(19) United States
(12) Patent Application Publication
(10) Pub. No.: US 2015/0342205 A1
(43) Pub. Date: Dec. 3, 2015

(54) METHODS OF PREPARING A FRESH CLEANED FISH CARCASS FOR STORAGE

(71) Applicants: David Mergle, Campbell River (CA); Stewart Hawthorn, Campbell River (CA); Barry Milligan, Campbell River (CA)

(72) Inventors: David Mergle, Campbell River (CA); Stewart Hawthorn, Campbell River (CA); Barry Milligan, Campbell River (CA)

(21) Appl. No.: 14/442,714

(22) PCT Filed: Nov. 13, 2012
(86) PCT No.: PCT/CA2012/001032

§ 371 Date: May 13, 2015

(51) Int. Cl. A23B 4/09; A22C 25/14; A23L 1/325

(52) U.S. Cl. CPC A23B 4/09; A23L 1/325; A22C 25/145; A23V 2002/00

(57) ABSTRACT

There is disclosed a method of preparing a fresh cleaned fish carcass for storage, the method comprising: positioning ice in an abdominal cavity of the fresh cleaned fish carcass; and after positioning the ice in the abdominal cavity of the fresh cleaned fish carcass, packaging the fresh cleaned fish carcass in a thermally insulated transportable container. There is also disclosed a method of preparing a fresh cleaned fish carcass for storage, the method comprising: immersing at least a portion of the fresh cleaned fish carcass in brine; and after immersing the at least a portion of the fresh cleaned fish carcass in the brine, packaging the fresh cleaned fish carcass in ice. There is also disclosed a thermally insulated transportable container comprising stored therein a fresh cleaned fish carcass having ice in an abdominal cavity of the fresh cleaned fish carcass.

### BACKGROUND

1. Field

The invention relates generally to preparing a fresh cleaned fish carcass for storage.

2. Related Art

Fish that are farmed or harvested from the wild for consumption are generally killed and cleaned soon after being removed from water. The resulting cleaned fish carcasses must often be stored and transported, for example stored and transported to a restaurant for preparation for human consumption. Such cleaned fish carcasses may be frozen to preserve the fish until it is ready for preparation for consumption, but some consumers prefer fish that has not been frozen, for example because of perceived greater taste and quality of fish that has not been frozen.

However, storing and transporting cleaned fish carcasses without freezing the cleaned fish carcasses can be challenging. For example, even when stored at relatively low temperatures close to a freezing point, unfrozen cleaned fish carcasses may decay to the point of being unfit for consumption, or may develop a “fishy” smell that some consumers may find unpleasant.

### SUMMARY

According to one illustrative embodiment, there is provided a method of preparing a fresh cleaned fish carcass for storage, the method comprising: positioning ice in an abdominal cavity of the fresh cleaned fish carcass; and after positioning the ice in the abdominal cavity of the fresh cleaned fish carcass, packaging the fresh cleaned fish carcass in a thermally insulated transportable container.

The method may further comprise, before positioning the ice in the abdominal cavity of the fresh cleaned fish carcass, immersing at least a portion of the fresh cleaned fish carcass in brine.

The brine may comprise a sodium chloride solution.

The sodium chloride solution may comprise a kosher salt solution.

The solution may be saturated with sodium chloride.

Immersing the at least a portion of the fresh cleaned fish carcass in the brine may comprise immersing the at least a portion of the fresh cleaned fish carcass in the brine for about 20 seconds.

Immersing the at least a portion of the fresh cleaned fish carcass in the brine may comprise immersing a portion of the fresh cleaned fish carcass posterior to but not including gills of the fish.

The method may further comprise, before immersing the at least a portion of the fresh cleaned fish carcass in the brine, further cleaning the fresh cleaned fish carcass.

Further cleaning the fresh cleaned fish carcass may comprise scraping inner surfaces of the fresh cleaned fish carcass.

Further cleaning the fresh cleaned fish carcass may comprise removing capillaries from the fresh cleaned fish carcass.

Further cleaning the fresh cleaned fish carcass may comprise removing pin veins from the fresh cleaned fish carcass.

Further cleaning the fresh cleaned fish carcass may comprise removing visceral fat from the fresh cleaned fish carcass.

Further cleaning the fresh cleaned fish carcass may comprise removing abdominal organs from the fresh cleaned fish carcass.

Removing abdominal organs from the fresh cleaned fish carcass may comprise removing kidneys from the fresh cleaned fish carcass.

The method may further comprise surrounding an outer surface of the fresh cleaned fish carcass in additional ice.

The fresh cleaned fish carcass may comprise a fresh cleaned salmon carcass.

According to another illustrative embodiment, there is provided a fresh cleaned fish carcass prepared according to the method.

According to another illustrative embodiment, there is provided a method of preparing a fresh cleaned fish carcass for storage, the method comprising: immersing at least a portion of the fresh cleaned fish carcass in brine; and after immersing the at least a portion of the fresh cleaned fish carcass in the brine, packaging the fresh cleaned fish carcass in ice.

Packaging the fresh cleaned fish carcass in the ice may comprise positioning at least some of the ice in an abdominal cavity of the fresh cleaned fish carcass.

Packaging the fresh cleaned fish carcass in the ice may comprise packaging the fresh cleaned fish carcass in the ice in a thermally insulated transportable container.

The brine may comprise a sodium chloride solution.

The sodium chloride solution may comprise a kosher salt solution.

The solution may be saturated with sodium chloride.

Immersing the at least a portion of the fresh cleaned fish carcass in the brine may comprise immersing the at least a portion of the fresh cleaned fish carcass in the brine for about 20 seconds.

Immersing the at least a portion of the fresh cleaned fish carcass in the brine may comprise immersing a portion of the fresh cleaned fish carcass posterior to but not including gills of the fish.

The method may further comprise, before immersing the at least a portion of the fresh cleaned fish carcass in the brine, further cleaning the fresh cleaned fish carcass.

Further cleaning the fresh cleaned fish carcass may comprise scraping inner surfaces of the fresh cleaned fish carcass.

Further cleaning the fresh cleaned fish carcass may comprise removing capillaries from the fresh cleaned fish carcass.

Further cleaning the fresh cleaned fish carcass may comprise removing pin veins from the fresh cleaned fish carcass.

Further cleaning the fresh cleaned fish carcass may comprise removing visceral fat from the fresh cleaned fish carcass.

Further cleaning the fresh cleaned fish carcass may comprise removing abdominal organs from the fresh cleaned fish carcass.

Removing abdominal organs from the fresh cleaned fish carcass may comprise removing kidneys from the fresh cleaned fish carcass.

The method may further comprise surrounding an outer surface of the fresh cleaned fish carcass in additional ice.

The fresh cleaned fish carcass may comprise a fresh cleaned salmon carcass.

According to another illustrative embodiment, there is provided a fresh cleaned fish carcass prepared according to the method.

According to another illustrative embodiment, there is provided a thermally insulated transportable container comprising stored therein a fresh cleaned fish carcass having ice in an abdominal cavity of the fresh cleaned fish carcass.

The thermally insulated transportable container may further comprise additional ice surrounding an outer surface of the fresh cleaned fish carcass.

The fresh cleaned fish carcass may comprise a fresh cleaned salmon carcass.

Other aspects and features of the present invention will become apparent to those ordinarily skilled in the art upon review of the following description of illustrative embodiments in conjunction with the accompanying figures.

### BRIEF DESCRIPTION OF THE DRAWINGS

FIG. 1 is a flow chart illustrating a method of preparing a fresh fish carcass for storage according to an illustrative embodiment.

FIG. 2 is an elevation view of a fresh fish carcass according to an illustrative embodiment.

FIG. 3 is a bottom view of the fresh fish carcass of FIG. 2 that has been cleaned according to an illustrative embodiment.

FIG. 4 is a cross-sectional view of the fresh cleaned fish carcass of FIG. 3, taken along the line IV-IV in FIG. 3.

### DETAILED DESCRIPTION

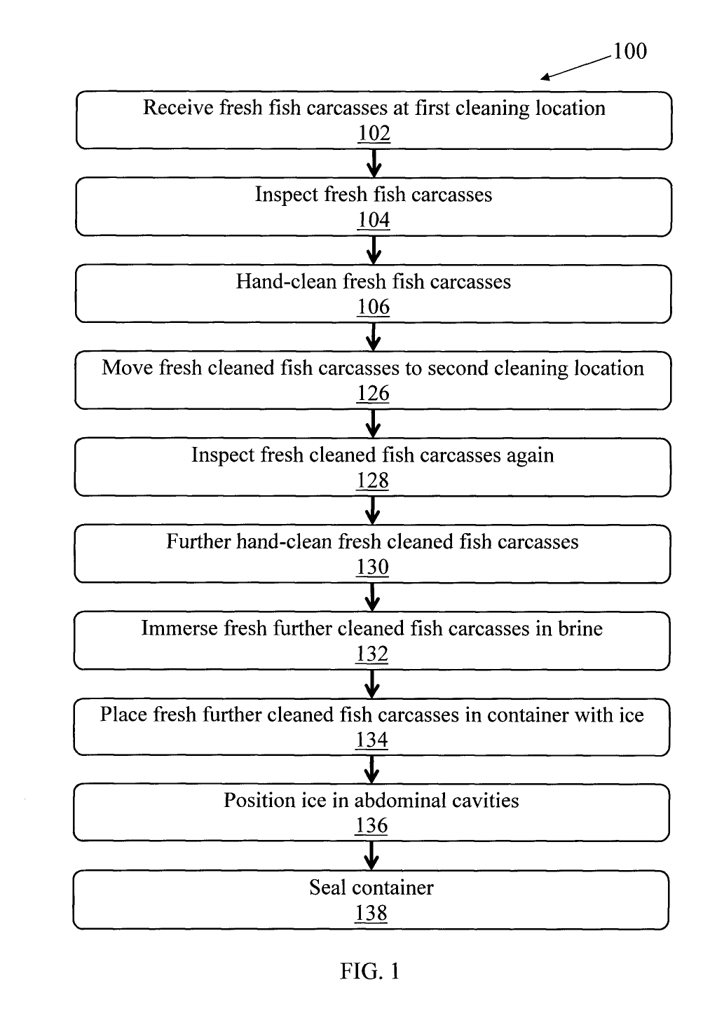

Referring to FIG. 1, a method of preparing a fresh fish carcass for storage according to an illustrative embodiment is shown generally at 100. The method 100 begins when fish are received at a fish processing plant. In various embodiments, the received fish may be farmed fish, fish caught from the wild, or a combination of farmed and wild fish. The fish may be salmon or various other fish. Often, the fish are already dead when received at the fish processing plant, but any fish that are still alive may be killed before proceeding with the method 100. Therefore, the following description of the method 100 refers to fish carcasses, and herein “carcass” may in various embodiments refer to some or all of the body of a dead fish.

Further, the following description of the method 100 refers to carcasses of fish that have been recently harvested, either from a farm or in the wild. For example, fish prepared according to the method 100 described below may have been removed from water recently before being received at the fish processing plant without having been frozen, and therefore carcasses of such fish may be referred to as “fresh” fish carcasses. Herein, “fresh” may in various embodiments refer to a fish carcass that has been removed from water recently and that has not been frozen.

The method 100 in the embodiment shown begins at 102 when fresh fish carcasses are received at a first cleaning location at the fish processing plant, and continues at 104 when the fresh fish carcasses received at 102 are inspected. In some embodiments, the inspection at 104 is brief (for example, from about 3 seconds to about 5 seconds) and may include various inspection steps including one or more visual external factors such as: checking for scars or lesions on the fish carcasses; checking that eyes of the fish carcasses are clear and not cloudy; checking that belly walls of the fish carcasses are sufficiently thick; checking that gills of the fish carcasses are red; checking for significant scale loss on the fish carcass; and checking that the fish carcasses are each at least about 10 pounds in weight (or about 4.5 kilograms in mass), or checking that the fish carcasses are each between about 10 pounds and about 12 pounds in weight (or between about 4.5 kilograms and about 5.4 kilograms in mass), for example.

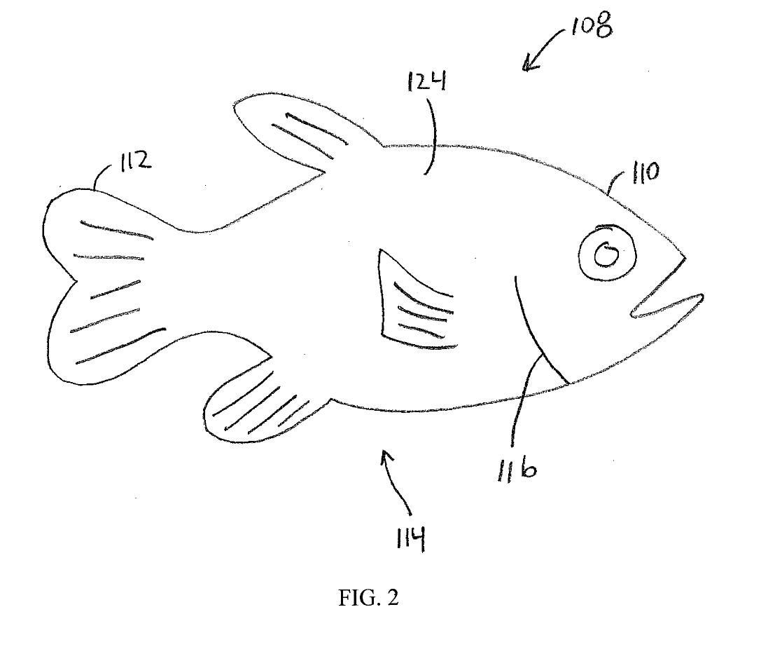

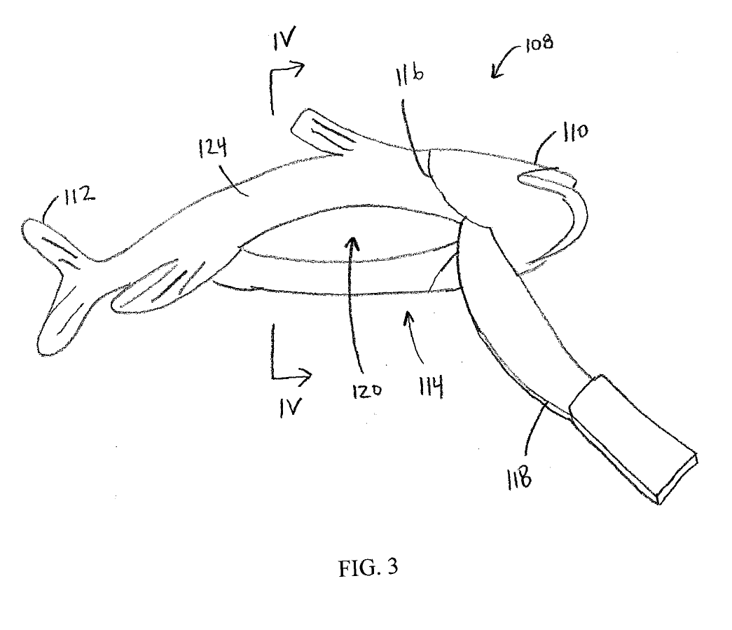

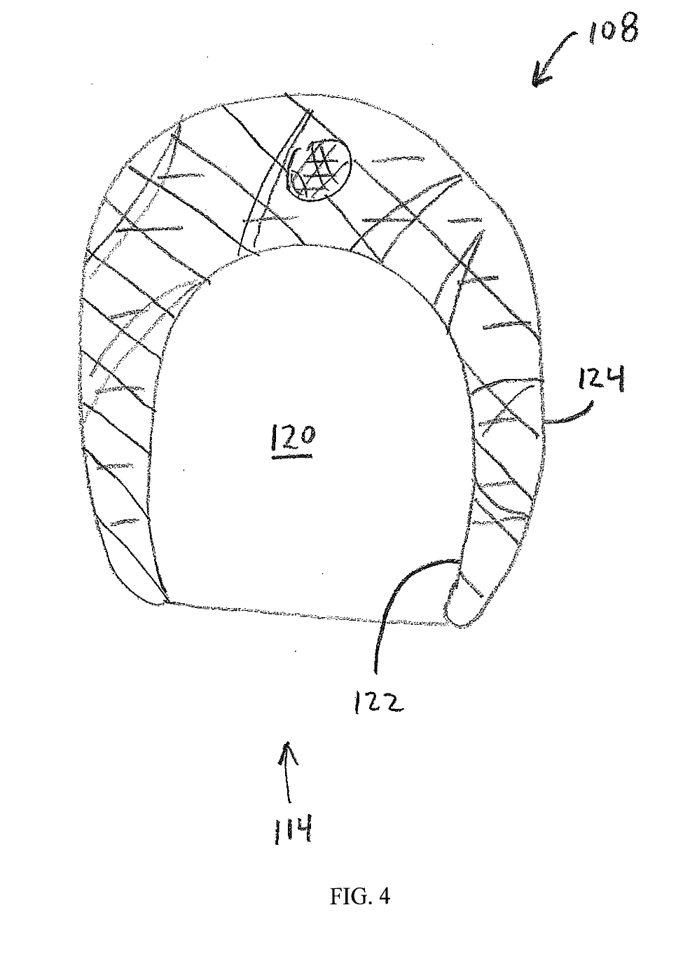

After being inspected at 104, the fresh fish carcasses received at 102 are hand-cleaned at 106. Referring to FIGS. 2 and 3, a fresh fish carcass according to an illustrative embodiment is shown generally at 108 and includes a head 110, a tail 112, an underside shown generally at 114, and gills 116. Hand-cleaning the fresh fish carcass 108 at 106 in the embodiment shown involves cutting open the fresh fish carcass along the underside 114 with a knife 118 as shown in FIG. 3, and gutting the fresh fish carcass 108 using a tool such as a spoon with a water jet. Referring to FIGS. 3 and 4, once the fresh fish carcass 108 is gutted, an abdominal cavity shown generally at 120, from which some or all abdominal organs of the fish have been removed, is opened. The abdominal cavity 120 is bounded by inner surfaces 122 of the fresh fish carcass 108, and the fresh fish carcass 108 also has outer surfaces 124.

Referring back to FIG. 1, although the fresh fish carcasses are hand-cleaned at 106 in the embodiment shown, alternative embodiments may clean the fresh fish carcasses at 106 by other methods. The fresh fish carcasses, once cleaned at 106, may be referred to herein as “fresh cleaned fish carcasses”.

In the embodiment shown, the fresh cleaned fish carcasses from 106 are moved at 126 to a second cleaning location. In various embodiments, for greater efficiency for example, the second cleaning location may be a different location from the first cleaning location, such as a different room from the first cleaning location in the fish processing plant, a different location in the same room as the first cleaning location in the fish processing plant, or even a different fish processing plant. The second cleaning location may also be the same as the first cleaning location in some embodiments.

In the embodiment shown, at the second cleaning location, the fresh cleaned fish carcasses from 106 are inspected again at 128. In some embodiments, the second inspection at 128 may include various inspection steps to select fresh cleaned fish carcasses (for example between about 6% and about 10% of the fresh fish carcasses received at 102 in some embodiments) that meet a high standard of quality. The second inspection at 128 may therefore be longer than the first inspection at 104 in some embodiments, and may last about one minute for example. The second inspection at 128 may include various inspection steps including one or more of: checking belly wall rigidity of the fresh cleaned fish carcasses; checking for minimal scale loss of the fresh cleaned fish carcasses; checking for maturing of the fish, which may be apparent from jaw hooking or bronzing, for example; and checking for watermarking on the scales of the fresh cleaned fish carcasses.

After being inspected at 128, the fresh cleaned fish carcasses are further hand-cleaned at 130 in the embodiment shown. Further hand-cleaning the fresh cleaned fish carcass 108 at 130 in the embodiment shown involves scraping the inner surfaces 122 of the abdominal cavity 120 of the fresh cleaned fish carcass 108 with a tool having a sharp edge to remove or “push” one or more of capillaries, pin veins, visceral fat, and any remaining abdominal organs (such as kidneys, for example) from the fresh cleaned fish carcass. For example, the tool may be a paddle, s scraper, or a spatula, may be plastic, and may be similar to an ice scraper for a car windshield but narrower.

After further hand-cleaning the fresh cleaned fish carcasses at 130, at least a portion of the fresh further cleaned fish carcasses in the embodiment shown are immersed in brine at 132. The brine in various embodiments may include a sodium chloride solution such as a solution of sodium chloride from kosher salt dissolved in fresh water. In various embodiments, the sodium chloride solution may be saturated with kosher salt at ambient temperature. In some embodiments, only a portion of a fresh further cleaned fish carcass posterior to but not including gills (such as a portion posterior to but not including the gills 116, or towards the tail 112 from the gills 116 but not including the gills 116, of the fresh fish carcass 108 shown in FIG. 1) of the fresh further cleaned fish carcasses may be immersed in the brine. Also, in various embodiments, the at least a portion of the fresh further cleaned fish carcass may be immersed in the brine for about 20 seconds.

After immersing the least a portion of the fresh further cleaned fish carcasses in brine at 132, the fresh further cleaned fish carcasses are placed in the embodiment shown at 134 in a container with flake ice made from freezing fresh water. In the embodiment shown, the container is a thermally insulated transportable container, for example such as the thermally insulated transportable container known as the ThermaFresh™ container available from the Cascades Specialty Products Group of 1061 Parent Street, St. Bruno, Québec, Canada, J3V 6R7 and described and illustrated in U.S. Pat. No. 7,975,905.

Once the fresh further cleaned fish carcasses are placed in the container with flake ice at 134, some of the flake ice may positioned at 136 in abdominal cavities (such as the abdominal cavity 120 of the fresh cleaned fish carcass 108) of the further cleaned fish carcasses in addition to the flake ice surrounding outer surfaces such as the outer surface 124 of the fresh cleaned fish carcass 108. Further, in some embodiments, the containers may be filled with flake ice once one or more further cleaned fish carcasses are positioned in the containers so that the flake ice may surround outer surfaces (such as the outer surface 124 of the fresh cleaned fish carcass 108) of the fresh cleaned fish carcasses and also fill their abdominal cavities. Although flake ice from fresh water has been described, alternative embodiments may include other types of ice. In some embodiments, three fresh cleaned fish carcasses may fit in one ThermaFresh™ container.

The containers may then be sealed at 138, for example with tamper-proof tape. Once the containers are sealed at 138, the containers may be stored and transported to various locations such as a restaurant where the fresh further cleaned fish carcasses may be prepared for consumption.

It has been found that preparing fresh fish carcasses for storage according to the method 100 may extend the time that the fresh cleaned fish carcasses are usable when compared to other methods of preparing fresh fish carcasses for storage.

Without wishing to be bound by any theory, it is believed that further hand-cleaning the fresh cleaned fish carcasses at 130 may remove some tissue (such as capillaries, pin veins, visceral fat, and abdominal organs such as kidneys) that may retain blood, and it is believed that removing such tissue may avoid a “fishy” smell that may develop during storage of unfrozen fresh cleaned fish carcasses and that some consumers may find unpleasant.

Again without wishing to be bound by any theory, it is further believed that immersing at least a portion of the fresh further cleaned fish carcasses in brine at 132 may kill some or all bacteria on the fresh further cleaned fish carcasses, which may defer or avoid decay of the fresh cleaned fish carcasses prepared for storage according to the method 100. Further, it is believed that immersing the fresh further cleaned fish carcasses in brine at 132 may provide sheen to the fresh cleaned fish carcasses prepared for storage according to the method 100.

Further, and again without wishing to be bound by any theory, it is believed that positioning ice in abdominal cavities of the fresh further cleaned fish carcasses at 136 may also defer or avoid decay of the fresh cleaned fish carcasses and extend perceived freshness and quality of the fresh cleaned fish carcasses by exposing more of the fresh cleaned fish carcasses to ice when compared to other methods of preparing fresh fish carcasses for storage. In general, it has been found that fresh fish carcasses prepared for storage according to the method 100 last longer and remain fresher than other fresh cleaned fish carcasses.

Although specific embodiments of the invention have been described and illustrated, such embodiments should be considered illustrative of the invention only and not as limiting the invention as construed in accordance with the accompanying claims.

1. (canceled)

2. (canceled)

3. A method of preparing a fresh cleaned fish carcass for storage, the method comprising:
immersing at least a portion of the fresh cleaned fish carcass in brine; and
after immersing the at least a portion of the fresh cleaned fish carcass in the brine, packaging the fresh cleaned fish carcass in ice.

4. The method of claim 3 wherein packaging the fresh cleaned fish carcass in the ice comprises positioning at least some of the ice in an abdominal cavity of the fresh cleaned fish carcass.

5. The method of claim 3 wherein packaging the fresh cleaned fish carcass in the ice comprises packaging the fresh cleaned fish carcass in the ice in a thermally insulated transportable container.

6. The method of claim 3 wherein the brine comprises a sodium chloride solution.

7. The method of claim 6 wherein the sodium chloride solution comprises a kosher salt solution.

8. The method of claim 6 wherein the solution is saturated with sodium chloride.

9. The method of claim 3 wherein immersing the at least a portion of the fresh cleaned fish carcass in the brine comprises immersing the at least a portion of the fresh cleaned fish carcass in the brine for about 20 seconds.

10. The method of claim 3 wherein immersing the at least a portion of the fresh cleaned fish carcass in the brine comprises immersing a portion of the fresh cleaned fish carcass posterior to but not including gills of the fish.

11. The method of claim 3 further comprising, before immersing the at least a portion of the fresh cleaned fish carcass in the brine, further cleaning the fresh cleaned fish carcass.

12. The method of claim 11 wherein further cleaning the fresh cleaned fish carcass comprises scraping inner surfaces of the fresh cleaned fish carcass.

13. The method of claim 11 wherein further cleaning the fresh cleaned fish carcass comprises removing capillaries from the fresh cleaned fish carcass.

14. The method of claim 11 wherein further cleaning the fresh cleaned fish carcass comprises removing pin veins from the fresh cleaned fish carcass.

15. The method of claim 11 wherein further cleaning the fresh cleaned fish carcass comprises removing visceral fat from the fresh cleaned fish carcass.

16. The method of claim 11 wherein further cleaning the fresh cleaned fish carcass comprises removing abdominal organs from the fresh cleaned fish carcass.

17. The method of claim 16 wherein removing abdominal organs from the fresh cleaned fish carcass comprises removing kidneys from the fresh cleaned fish carcass.

18. The method of claim 3 further comprising surrounding an outer surface of the fresh cleaned fish carcass in additional ice.

19. The method of claim 3 wherein the fresh cleaned fish carcass comprises a fresh cleaned salmon carcass.

20. A fresh cleaned fish carcass having brine on a portion of the fresh cleaned fish carcass, and having ice positioned in an abdominal cavity of the fresh cleaned fish carcass.

21. A thermally insulated transportable container comprising stored therein a fresh cleaned fish carcass having brine on a portion of the fresh cleaned fish carcass, and having ice in an abdominal cavity of the fresh cleaned fish carcass.

22. The thermally insulated transportable container of claim 21 further comprising additional ice surrounding an outer surface of the fresh cleaned fish carcass.

23. The thermally insulated transportable container of claim 21 wherein the fresh cleaned fish carcass comprises a fresh cleaned salmon carcass.
